(19) United States
(12) Patent Application Publication
(10) Pub. No.: US 2015/0072746 A1
(43) Pub. Date: Mar. 12, 2015

(54) VIRTUAL GOLF SIMULATION APPARATUS AND METHOD

(71) Applicant: GOLFZON Co., Ltd., Daejeon (KR)

(72) Inventor: Cheol Ho JANG, Incheon (KR)

(21) Appl. No.: 14/540,043

(22) Filed: Nov. 13, 2014

Related U.S. Application Data
(63) Continuation of application No. 13/498,691, filed on Mar. 28, 2012.

(30) Foreign Application Priority Data
Sep. 29, 2009 (KR) 10-2009-0092613

(51) Int. Cl. A63F 13/63; A63F 13/812

(52) U.S. Cl. CPC A63F 13/63; A63F 13/812
USPC 463/3

(57) ABSTRACT

A virtual golf simulation apparatus and method are provided. In the apparatus and method, a golfer is allowed to selectively or arbitrarily set a hole-cup position on a green during a simulation procedure of a virtual golf course and a hole-cup is generated at the set position to provide virtual golf simulation environments meeting various needs of golfers who enjoy virtual golf games while arousing their interest. The virtual golf simulation apparatus for a golf course includes a setting unit for setting a hole-cup position on a putting green and an image processing unit for generating and rendering a hole-cup at the set hole-cup position on the putting green.

### CROSS REFERENCE TO PRIOR APPLICATIONS

This application is a Continuation Application of U.S. patent application Ser. No. 13/498,691 filed on Mar. 28, 2012 under 35 U.S.C. §120, which is a National Stage Patent Application of PCT International Patent Application No. PCT/KR2010/006562 filed on Sep. 28, 2010 under 35 U.S.C. §371, which claims priority to Korean Patent Application No. 10-2009-0092613 filed on Sep. 29, 2009, which are all hereby incorporated by reference in their entirety.

### BACKGROUND

The present invention relates to a virtual golf simulation apparatus and method, and more particularly to a virtual golf simulation apparatus and method in which a virtual golf course is rendered (or visualized) and simulated and a track of a golf ball struck by a user, i.e., a golfer, is simulated in the virtual golf course.

Golf is a game that is played by striking a golf ball from a tee box to a green to sink it into a hole-cup. Especially, putting on a green is a very challenging and difficult part of the game since the golfer should correctly judge the lie on the green and strike the golf ball with accurate force, direction, and the like.

The position of the hole-cup is very important for golfers when putting since strategies required for each hole such as approach and putting style strategies vary depending on where the hole-cup is located on the putting green.

For example, when the golfer hits an approach shot when the hole-cup is located near a rear edge of the green, the golfer should very carefully strike the golf ball since the ball may easily cross the green.

A virtual golf simulation apparatus includes a screen installed indoors for displaying a virtual golf course. When the user strikes a golf ball toward the screen, the virtual golf simulation apparatus senses the speed, direction, and the like of the golf ball and displays the movement of the golf ball on the screen. The virtual golf simulation apparatus allows the user to play through the virtual golf course with a sense of realism as though they were playing a real golf course while striking the golf ball in the same manner as when striking a golf ball on a driving range.

Special functions, which cannot be implemented during a real round of golf, can be performed in a virtual round of golf provided by the virtual golf simulation apparatus. Such functions need to provide convenience to golfers, who enjoy virtual golf games, and to arouse their interest.

### SUMMARY OF THE INVENTION

Therefore, the present invention has been made in view of the above circumstances, and it is an object of the present invention to provide a virtual golf simulation apparatus and method in which a golfer is allowed to selectively or arbitrarily set a hole-cup position on a green during a simulation procedure of a virtual golf course and a hole-cup is generated at the set position to provide virtual golf simulation environments meeting various needs of golfers who enjoy virtual golf games while arousing their interest.

In accordance with an aspect of the present invention, the above and other objects can be accomplished by the provision of a virtual golf simulation apparatus, the apparatus including a setting means which sets a hole-cup position on a putting green in an virtual golf simulation image, and an image processing means which generates and render a hole-cup at the set hole-cup position on the putting green.

In accordance with another aspect of the present invention, there is provided a virtual golf simulation apparatus, the apparatus including a storage unit which stores information regarding hole-cup position setting and putting green information in an virtual golf simulation image, a manipulation means which performs a manipulation for arbitrarily or selectively setting a hole-cup position on a putting green based on the information regarding the hole-cup position stored in the storage unit, and an image processing unit which generates and outputs a putting green and an image associated with hole-cup position setting and generating and rendering a hole-cup at the set position on the putting green based on the information stored in the storage unit.

In accordance with another aspect of the present invention, there is provided a virtual golf simulation method, the method including displaying image information for setting a hole-cup position on a putting green in an virtual golf simulation image, setting a position at which a hole-cup is to be generated on the putting green, and generating a hole-cup at the set position on the putting green.

In the virtual golf simulation apparatus and method according to the present invention, a golfer can selectively or arbitrarily set a hole-cup position on a green during a simulation procedure of a virtual golf course and a hole-cup is generated at the set position, thereby providing virtual golf simulation environments meeting various needs of golfers who enjoy virtual golf games while arousing their interest.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a screen golf system which employs a virtual golf simulation apparatus according to an embodiment of the present invention;

FIG. 2 is a block diagram illustrating a control system of the virtual golf simulation apparatus according to the embodiment of the present invention;

FIG. 3 illustrates the screen golf system which employs the virtual golf simulation apparatus according to an embodiment of the present invention having another exemplary manipulation means;

FIG. 4 illustrates a method for setting a position at which a hole-cup is to be generated on a green in the virtual golf simulation apparatus according to the embodiment of the present invention;

FIG. 5 illustrates an example of a selection menu used for selecting a green and a hole-cup position in the virtual golf simulation apparatus according to the embodiment of the present invention;

FIG. 6 illustrates another method for setting a position at which a hole-cup is to be generated on a green in the virtual golf simulation apparatus according to the embodiment of the present invention;

FIG. 7 is a flow chart illustrating a virtual golf simulation method according to an embodiment of the present invention; and

FIG. 8 illustrates an exemplary hole-cup generation method used in the virtual golf simulation method according to the embodiment of the present invention.

### DETAILED DESCRIPTION

Embodiments of a virtual golf simulation apparatus and method according to the present invention will now be described in more detail with reference to the drawings.

The virtual golf simulation apparatus and method according to the present invention can be implemented in a variety of forms and can be typically applied to a so-called screen golf system.

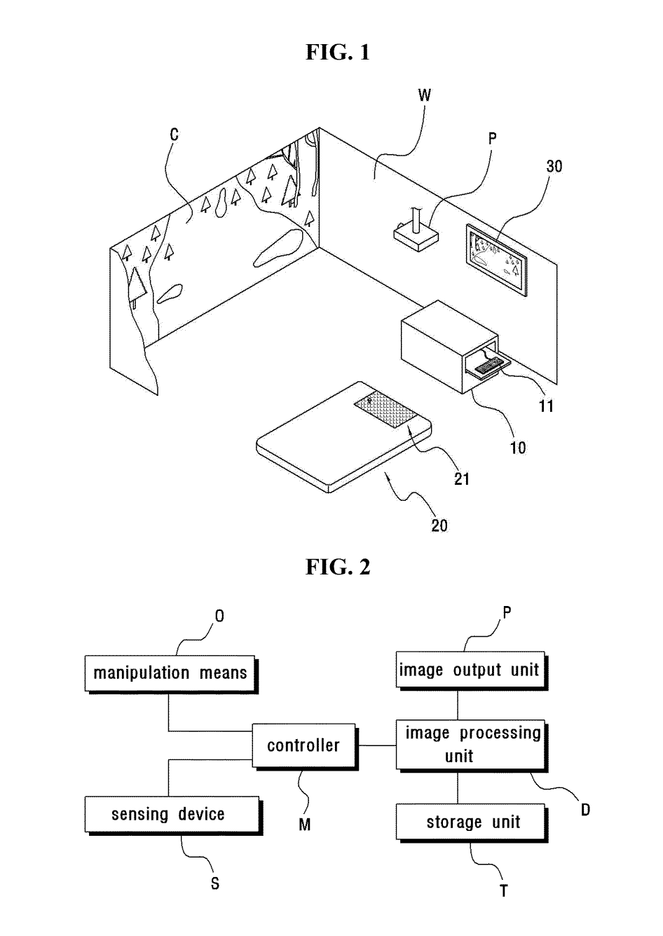

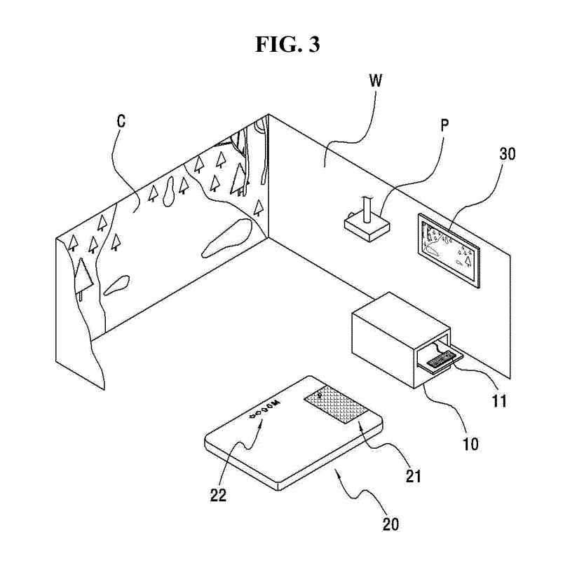

FIGS. 1 and 3 illustrate an example in which the virtual golf simulation apparatus and method according to the present invention are applied to a screen golf system. Although not illustrated, the present invention can also be applied to any other type of system or apparatus which simulates and renders (or visualizes) a virtual golf course and simulates and renders a virtual golf ball.

The example in which the virtual golf simulation apparatus and method according to the present invention are applied to a screen golf system is described below in detail with reference to FIGS. 1 to 3.

As shown in FIGS. 1 and 2, the virtual golf simulation apparatus according to an embodiment of the present invention includes a swing plate 20, a sensing device S, an image output device P, and a simulator. The image output device P outputs an image to a screen C provided at a front side. The simulator performs storage, processing, and the like on all data required for virtual golf simulation. The simulator is provided in a protective housing 10 as shown in FIG. 1.

The simulator may include an image processing unit D, a storage unit T, and a controller M.

The storage unit T stores all data required for virtual golf simulation, including data regarding virtual golf courses. The image processing unit D processes data of all virtual golf simulation related images stored in the storage unit T, including virtual golf course related images, golf ball movement images, and images for menu selection.

The controller M performs a variety of calculations for virtual golf simulation, overall control of the components, and the like.

Specifically, when a golfer strikes a golf ball toward the screen C on the swing plate 20, the sensing device S senses the striking and provides the sensed signal to the controller M and the controller M then provides the sensed signal to the image processing unit D. The image processing unit D retrieves golf simulation image information such as a movement image of the golf ball from the storage unit T and creates a corresponding image taking into consideration the movement pattern of the golf ball. The golf game is performed through virtual simulation while projecting the created image onto the screen C through the image output device P.

Although not shown in detail in FIG. 1, the sensing device S (see FIG. 2) may be implemented by infrared light emitting/receiving sensors installed at the side of the swing plate 20 or may be implemented by a camera sensor mounted on the ceiling, a wall, or the like and may also be implemented by any other type of sensor.

The virtual golf simulation apparatus according to this embodiment also includes a manipulation means O that allows the user to perform manipulations for settings such as system settings or various settings for playing a golf game.

In FIG. 1, a keyboard 11 provided on the protective housing 10 including the simulator is shown as an example of the manipulation means O. The touch screen 30 provided on a side wall W may also be provided as an example of the manipulation means O. Although not illustrated, a mouse device is preferably provided together with the keyboard 11.

Although not illustrated, a remote control (not shown) may be provided as the manipulation means O to perform manipulation associated with virtual golf simulation while directly communicating with the simulator or directly communicating with the touch screen.

FIG. 3 illustrates a key operating unit 22 provided on the swing plate 20 as an example of the manipulation means.

Since a golfer standing on the swing plate 20 cannot conveniently manipulate the keyboard 11 or the touch screen 30 shown in FIG. 1, the key operating unit 22 is preferably provided on the swing plate 20 so as to allow a golfer who is ready to swing to easily perform manipulation for virtual golf simulation setting.

A keypad (not shown) may also be provided near the swing plate 20 as a device enabling the golfer to perform manipulation for virtual golf simulation setting. The keypad (not shown) may be selectively provided in combination with the keyboard 11 or with the touch screen 30. Forward, backward, left, and right navigation keys may be provided on the keypad to allow the golfer to easily adjust various settings or to easily perform aiming in the virtual golf simulation procedure.

The virtual golf simulation apparatus according to the present invention basically includes any means for allowing a hole-cup position to be arbitrarily or selectively set by a user, i.e., by a golfer, so that a hole-cup is generated and rendered at the arbitrarily or selectively set position on a putting green in a virtual golf course.

Respective hole-cup positions of holes may be collectively set in a selection menu before a virtual round of golf starts and the hole-cup position of each hole may also be individually set during a virtual round of golf at the hole.

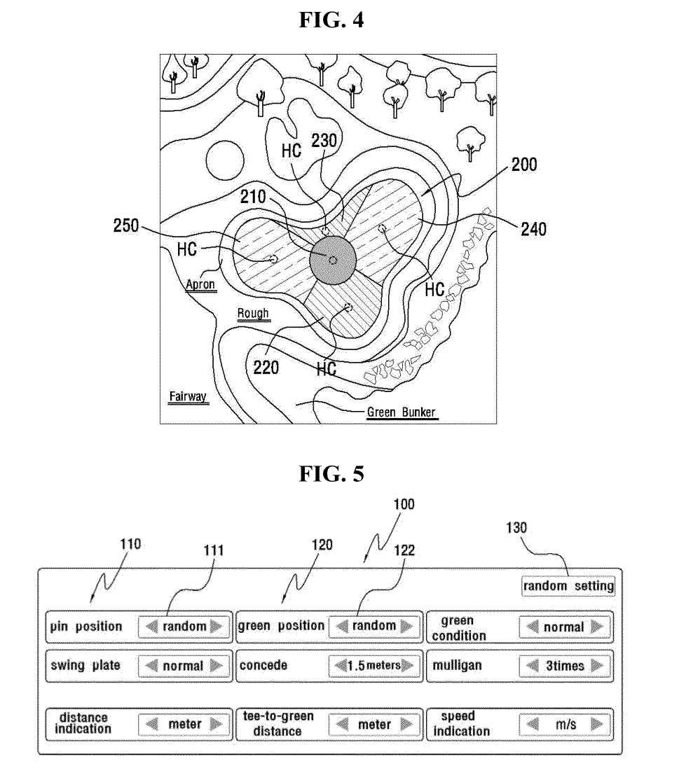

FIG. 4 illustrates an example in which the user selects the position of a hole-cup on a putting green of a virtual golf course.

As shown in FIG. 4, the virtual golf course may be provided as images of a fairway, a rough, a green bunker, an apron, a putting green 200, and the like. The images may be implemented as a different golf course according to the characteristics of each hole.

The putting green 200 may be divided into a middle pin region 210, a front pin region 220, a rear pin region 230, a right pin region 240, and a left pin region 250.

A center region of the putting green 200 may be set as the middle pin region 210 and the area surrounding the middle pin region 210 may be divided into the front pin region 220, the rear pin region 230, the right pin region 240, and the left pin region 250.

The user may select one of the middle pin region 210, the front pin region 220, the rear pin region 230, the right pin region 240, and the left pin region 250 through the manipulation means O (see FIG. 2) and a hole-cup HC is generated at a preset position in the selected region. Since all holes have different greens, some of the regions may be set to be selectable or may be set to be locked according to the green condition of each hole. This setting is determined according to a rule preset in the controller.

The position of the hole-cup HC on the putting green 200 may be individually set on each hole in a golf course that is currently being played or may be collectively selected for all holes during initial system setting.

The middle pin region 210, the front pin region 220, the rear pin region 230, the right pin region 240, and the left pin region 250 may be indicated by flags having different colors.

FIG. 5 illustrates an example of a selection menu that allows the user to set the position of a hole-cup on a screen.

As shown in FIG. 5, a pin (hole-cup) position setting tab 110 and a green position setting tab 120 are displayed in the selection menu 100 and various other tabs may also be provided in the selection menu 100.

An option display portion for pin position 111, which allows the user to select one of a middle pin, a front pin, a rear pin, a right pin, a left pin, and a random (a random selected one of the pins), is displayed in the pin position setting tab 110 and an option display portion for green position 122, which allows the user to select one of a left green, a right green, and a random(a random selected one of the greens), is displayed in the green position setting tab 120.

The green position selection tab is used to select a green from a hole having a plurality of (optional) greens.

Typically, two greens, which are referred to as “left and right greens”, are displayed on one hole. When the two greens are displayed, the green position selection tab is used to select one of the two greens to play the game.

The random green position selection function is used to allow the system to automatically select and set one green in a random manner.

The random pin position selection function is used to allow the system to automatically select and set one of the middle, front, rear, right, and left pins in a random manner.

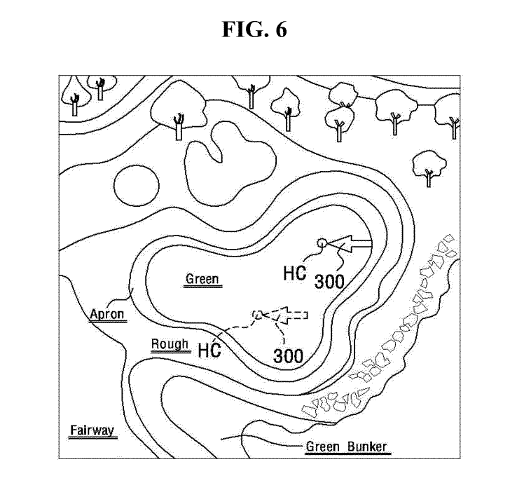

FIG. 6 illustrates a virtual golf simulation method according to another embodiment of the present invention in which the user directly specifies the position of a hole-cup on a putting green.

When a putting green 200 is displayed, a pointer 300 is displayed together with the putting green 200 as shown in FIG. 6. The user can generate a hole-cup HC at a desired position by moving the pointer 300 through the manipulation means O (see FIG. 2).

The user can arbitrarily specify (that is designation by the user to specify) the position of the hole-cup using a keyboard, a key operating unit, a touch screen, or a remote control and can also arbitrarily specify the position of the hole-cup using a mouse.

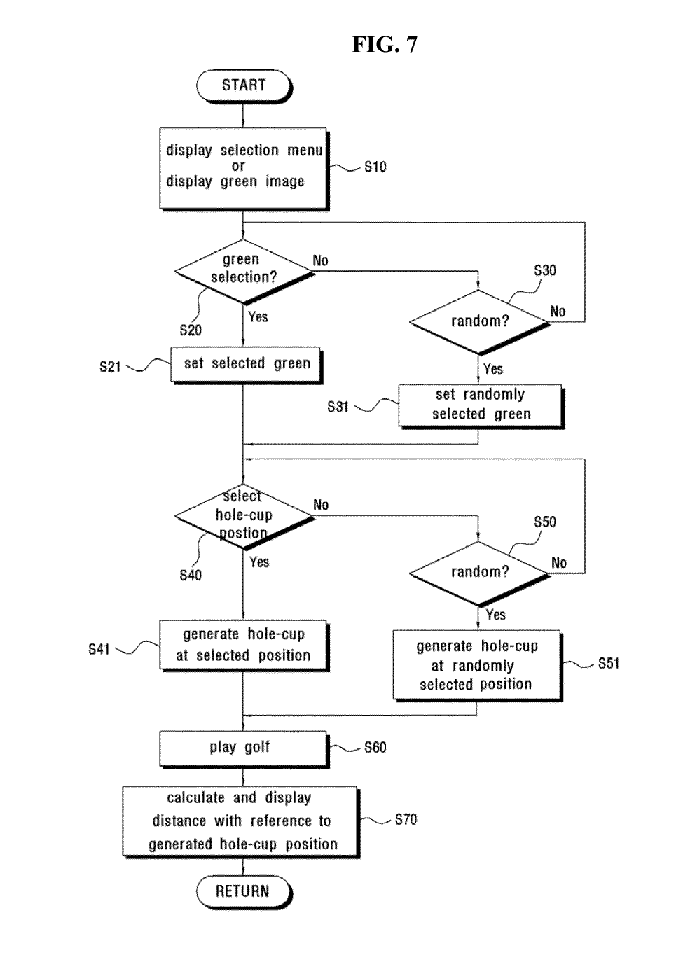

A virtual golf simulation method according to an embodiment of the present invention is described below with reference to FIG. 7.

The procedure shown in FIG. 7 may be performed in an initial system setting procedure of a virtual round of golf and may also be individually performed at each hole in the virtual round of golf.

First, a putting green image or a selection menu is displayed for hole-cup position setting (S10). Here, when a putting green image is displayed, the putting green image may be displayed together with a middle pin region, a front pin region, a rear pin region, a right pin region, and a left pin region or the putting green image alone may be displayed to allow the user to arbitrarily set the hole-cup position.

On the other hand, when a plurality of (putting) greens is displayed, the user selects a green to be played (S20). When the user selects one of the plurality of greens, the selected green is set as a green where a hole-cup is to be generated (S21). One of the plurality of greens may also be randomly selected (S30). When one of the plurality of greens is randomly selected, the randomly selected green is set as a green where a hole-cup is to be generated (S31).

After a green to be played is selected, a hole-cup position is set on the selected green. The user may select one of a plurality of preset hole-cup positions (S40) and may also designate to specify a hole-cup position (i.e., may also place a hole-cup anywhere on the putting green). When the user selects a random selection function (S50), the system randomly sets a hole-cup position on the green.

After the hole-cup position is selected or specified, a hole-cup is generated at the set position (S41). Alternatively, a hole-cup is generated at the randomly selected position (S51).

After the hole-cup position is set and the hole-cup is generated as described above, the golf game is played (S60). While the golf game is played, values such as a tee-to-green distance of each hole and a remaining distance after each stroke are calculated with reference to the position of the generated hole-cup and the calculated values are displayed (S70).

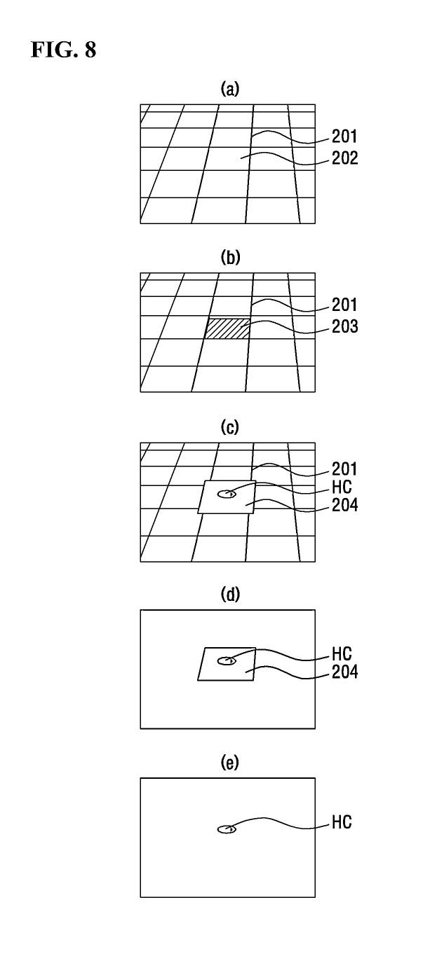

An exemplary procedure in which a hole-cup is generated at a set position is described below with reference to FIG. 8.

A green is divided into sections in a grid (or mesh) form 201 as shown in FIG. 8(a) and a section 202 including a position at which a hole-cup is generated is removed from the green as shown in FIG. 8(b). After the section 202 is removed, an empty section 203 remains on the green.

A section 204 in which a hole-cup HC is generated is arranged in the empty section 203 as shown in FIG. 8(c). Here, the size of the section 204 where the hole-cup HC is generated is preferably slightly greater than that of the removed section 203 as shown in FIG. 8(c).

Edge portions of the section 204 in which the hole-cup HC is generated are corrected according to surrounding topography as shown in FIG. 8(d). After the edge portions of the section 204 are corrected, a hole-cup is generated on the green as shown in FIG. 8(e).

The hole-cup generation method is only an example of the virtual golf simulation method according to the present invention and the virtual golf simulation apparatus according to the present invention includes any method for generating a hole-cup at a position set on a green.

Various embodiments of a virtual golf simulation apparatus and method according to the present invention have been described in the above best mode section.

The virtual golf simulation apparatus and method according to the present invention may be widely used in golf-game-related or simulation-related industrial fields since the apparatus and method can provide virtual reality golf game environments which meet various user needs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for realizing a virtual golf simulation environment on a virtual golf simulation apparatus for implementing a virtual golf course including a plurality of holes realized by imaging processing and for a user to play a round of golf on the implemented virtual golf course by sensing a golf ball hit by the user and simulating the golf ball movement in the virtual golf course based on the sensing, the method comprising:
displaying a selection menu including an option display portion for pin position which allows the user to select an item among a plurality of items for collectively setting a hole-cup position on a putting green in each hole of the holes of the virtual golf course for the user's virtual golf round;
setting the putting green in each hole of the holes to be divided into at least two of pin regions corresponding to the items of the selection menu, and setting the hole-cup position at a predetermined position on the a pin region corresponding to an item selected by the user through the option display portion for pin position of the selection menu on the putting green of each hole of the holes, wherein the hole-cup position on each hole of the holes of the virtual golf course is collectively set before the user's virtual golf round starts;
realizing each hole of the virtual golf course by the imaging processing; and
generating an image of a hole-cup at the set hole-cup position on a putting green when the putting green appears in a hole in which the user plays during the virtual golf round on the virtual golf course.

2. The method according to claim 1, wherein the items of the selection menu include a middle pin, a front pin, a rear pin, a right pin, and a left pin and a random, and the pin regions divided on the putting green in each hole of the holes include a middle pin region corresponding to the item of the middle pin, a front pin region corresponding to the item of the front pin, a rear pin region corresponding to the item of the rear pin, a right pin region corresponding to the item of the right pin, and a left pin region corresponding to the item of the left pin.

3. The method according to claim 1, further comprising the step of:
displaying a selection menu for individually selecting a pin position regarding a specific hole in which the user is playing virtual golf;
setting the hole-cup position at a predetermined position on the a pin region corresponding to an item selected by the user through the selection menu for individually selecting a pin position on the putting green of the specific hole; and
generating an image of a hole-cup at the set hole-cup position on the putting green of the specific hole.

4. The method according to claim 1, wherein the step of generating the image of the hole-cup comprises displaying the hole-cup on the pin region among the divided regions by a flag having a color different from a flag of another region's hole-cup position.

5. The method according to claim 1, wherein the step of generating the image of the hole cup comprises:
dividing the pin region corresponding to the item selected from the selection menu into a plurality of sections;
removing a specific section corresponding to the set hole-cup position from the plurality of sections;
arranging a substitute section illustrating the hole-cup on the section-removed portion, wherein a size of the substitute section is greater than that of the removed section so that the substitute section covers the section-removed portion and overlaps with adjacent sections surrounding the section-removed portion; and
correcting edge portions of the substitute section according to surrounding topography.

6. A method for realizing a virtual golf simulation environment on a virtual golf simulation apparatus for implementing a virtual golf course including a plurality of holes realized by imaging processing and for a user to play a round of golf on the implemented virtual golf course by sensing a golf ball hit by the user and simulating the golf ball movement in the virtual golf course based on the sensing, the method comprising:
displaying a selection menu including a pin position setting tab and a green position setting tab so that the selection menu allows the user to set a position of a hole-cup and a position of a putting green in each hole of the holes of the virtual golf course for the user's virtual golf round, wherein the pin position setting tab has an option display portion for pin position which allows the user to select an item among a plurality of items for collectively setting a hole-cup position on a putting green in each hole of the holes of the virtual golf course, and the green position setting tab has an option display portion for green position which allows the user to select an item among a plurality of items for collectively setting a green position regarding holes having a plurality of greens;
collectively setting the hole-cup position and the green position in each hole of the holes of the virtual golf course according to the user's selections through the selection menu;
realizing each hole of the virtual golf course by the imaging processing; and
generating an image of a hole-cup at the set hole-cup position on a putting green according to the set green position when the putting green appears in a hole in which the user plays during the virtual golf round on the virtual golf course.

7. The method according to claim 6, wherein the items on the option display portion for pin position include a middle pin, a front pin, a rear pin, a right pin, and a left pin and a random, and the items on the option display portion for green position include a left green, a right green and a random.

8. The method according to claim 7, wherein the step of collectively setting comprises setting the putting green in each hole of the holes to be divided into at least two of a middle pin region corresponding to the item of the middle pin, a front pin region corresponding to the item of the front pin, a rear pin region corresponding to the item of the rear pin, a right pin region corresponding to the item of the right pin, and a left pin region corresponding to the item of the left pin, and setting the hole-cup position at a predetermined position on the a pin region corresponding to an item selected by the user through the option display portion for pin position of the selection menu on the putting green of each hole of the holes, wherein the hole-cup position on each hole of the holes of the virtual golf course is collectively set before the user's virtual golf round starts.

9. The method according to claim 8, wherein the step of generating the image of the hole cup comprises:
dividing the pin region corresponding to the item selected from the selection menu into a plurality of sections;
removing a specific section corresponding to the set hole-cup position from the plurality of sections;
arranging a substitute section illustrating the hole-cup on the section-removed portion, wherein a size of the substitute section is greater than that of the removed section so that the substitute section covers the section-removed portion and overlaps with adjacent sections surrounding the section-removed portion; and
correcting edge portions of the substitute section according to surrounding topography.

10. A virtual golf simulation apparatus for realizing a virtual golf simulation environment on a virtual golf simulation apparatus for implementing a virtual golf course including a plurality of holes realized by imaging processing and for a user to play a round of golf on the implemented virtual golf course by sensing a golf ball hit by the user and simulating the golf ball movement in the virtual golf course based on the sensing, the apparatus comprising:
a sensing device;
an image output device;
a simulator, wherein the simulator comprising:
a storage unit for storing all data required for virtual golf simulation including data regarding virtual golf courses;
an image processing unit processing data of all virtual golf simulation related images stored in the storage unit, including virtual golf course related images, golf ball movement images, and images for menu selection; and
a controller performing a variety of calculations for virtual golf simulation, wherein the controller processes the steps of:
displaying a selection menu including an option display portion for pin position which allows the user to select an item among a plurality of items for collectively setting a hole-cup position on a putting green in each hole of the holes of the virtual golf course for the user's virtual golf round;
setting the putting green in each hole of the holes to be divided into at least two of pin regions corresponding to the items of the selection menu, and setting the hole-cup position at a predetermined position on the a pin region corresponding to an item selected by the user through the option display portion for pin position of the selection menu on the putting green of each hole of the holes, wherein the hole-cup position on each hole of the holes of the virtual golf course is collectively set before the user's virtual golf round starts;
realizing each hole of the virtual golf course by the imaging processing; and
generating an image of a hole-cup at the set hole-cup position on a putting green when the putting green appears in a hole in which the user plays during the virtual golf round on the virtual golf course.

11. The apparatus according to claim 10, wherein the items of the selection menu include a middle pin, a front pin, a rear pin, a right pin, and a left pin and a random, and the pin regions divided on the putting green in each hole of the holes include a middle pin region corresponding to the item of the middle pin, a front pin region corresponding to the item of the front pin, a rear pin region corresponding to the item of the rear pin, a right pin region corresponding to the item of the right pin, and a left pin region corresponding to the item of the left pin.

12. The apparatus according to claim 10, wherein the controller further processes the steps of:
dividing the pin region corresponding to the item selected from the selection menu into a plurality of sections;
removing a specific section corresponding to the set hole-cup position from the plurality of sections;
arranging a substitute section illustrating the hole-cup on the section-removed portion, wherein a size of the substitute section is greater than that of the removed section so that the substitute section covers the section-removed portion and overlaps with adjacent sections surrounding the section-removed portion; and
correcting edge portions of the substitute section according to surrounding topography.

13. The apparatus according to claim 10, wherein the controller further processes the step of calculating a tee-to-green distance and a remaining distance in a hole in which the user plays virtual golf based on the set green position and the set hole-cup position.
